(19) United States
(12) Patent Application Publication
(10) Pub. No.: US 2011/0043954 A1
(43) Pub. Date: Feb. 24, 2011

(54) ELECTROSTATIC DISCHARGE PROTECTION STRUCTURE AND ELECTRONIC DEVICE USING THE SAME

(75) Inventors: Ming-Wei Chuang, Taipei County (TW); Chuan-Wang Chang, Tapei County (TW)

Correspondence Address: J C PATENTS, 4 VENTURE, SUITE 250, IRVINE, CA, 92618, US

(73) Assignee: KINPO ELECTRONICS, INC., Taipei County (TW)

(21) Appl. No.: 12/574,087

(22) Filed: Oct. 6, 2009

(30) Foreign Application Priority Data
Aug. 21, 2009 (TW) 98128250

(51) Int. Cl. H02H 9/00

(52) U.S. Cl. 361/56

(57) ABSTRACT

An electrostatic discharge (ESD) protection structure and an electronic device using the same are provided. The ESD protection structure includes a discharge structure and a conduction structure, wherein the discharge structure and the conduction structure respectively have a pointed end, and the pointed ends thereof are adjacent to each other. The discharge structure and the conduction structure are both disposed on a bottom side of a printed circuit board (PCB) substrate, wherein the conduction structure is connected to a ground line and the discharge structure is connected to a signal line disposed on a top side of the PCB substrate through a via. Therefore, the top side of the substrate is not required to save a layout region for disposing the ESD protection structure, and moreover an original ESD protection effect is still maintained.

### CROSS-REFERENCE TO RELATED APPLICATION

This application claims the priority benefit of Taiwan application serial no. 98128250, filed Aug. 21, 2009. The entirety of the above-mentioned patent application is hereby incorporated by reference herein and made a part of specification.

### BACKGROUND OF THE INVENTION

1. Field of the Invention

The present invention relates to an electrostatic discharge protection structure. More particularly, the present invention relates to an electrostatic discharge protection structure adapted to a printed circuit board (PCB).

2. Description of Related Art

During a fabrication process of an integrated circuit (which is referred to as an IC or a chip), or after fabrication of the chip is completed, an electrostatic discharge (ESD) event is generally a main reason that cause a damage of the IC. Especially, during an assembling process of a printed circuit board (PCB), a contact between human body or a machine and the PCB can cause the ESD event, which may damage the chips or devices on the PCB. Therefore, the IC generally requires an ESD protection function to avoid being damaged due to an external ESD current.

The PCB is mainly used for integrating electronic devices, circuits and ICs to form electronic components. During a fabrication process and an assembling process of the PCB, the PCB probably contacts operator's hand, other PCBs or related assembling machines, and test machines, etc, which may lead to occurrence of the ESD event, so that the ICs on the PCB can be damaged.

The ESD event is liable to be occurred at a junction of the PCB and a flexible flat cable (FFC), the ESD current probably intrudes into the chips in the PCB assembly through signal lines at the junction and causes a damage. Presently, importance of the ESD protection in the electronic products, devices and equipments is undoubted, though conditions such as price, structure and space required for achieving the ESD protection are unattainable for electronic products with simple structures and low prices, so that how to design a cheap and efficient ESD protection solution with a limited cost is a major subject to engineers.

Presently, several commonly used cable ESD protection methods are as follows:

(1) ESD protection devices such as passive devices of ESD diodes, resistors, capacitors, inductors, etc. are configured on the PCB. Adding of these devices can change or lead an ESD path, though these devices have to be configured to each of cable pins, so as to achieve a comprehensive protection effect. Such method is applicable if a number of the cable pins is relatively less, though if the number of the cable pins is more than 30-40, problems of limited layout space and high cost are occurred.
(2) A length of the cable is elongated, such method has a similar effect to the method of adding resistors on the PCB. Relatively long cable has a relatively high impedance, which can change an intruding path of the ESD. Though, the longer the cable is, the higher the cost thereof is, and an excessive length of the cable may increase a chance of the ESD intrusion.
(3) The cable with a short length is used to depart from a source where the ESD is occurred, so as to reduce a chance of the ESD intrusion, though the current electronic products have a general trend of miniaturization, so that an effect of shortening the cable length is not as good as expectation. Moreover, such method may lead to a difficulty for production operation.
(4) The cable is wrapped with an antistatic material, though such method may achieve a comprehensive ESD protection effect, selection of the antistatic material is very important, and a cost thereof is determined by a using area and usage material of the antistatic material, which may also increase a fabrication cost.

Whatever the aforementioned ESD protection method is used, the fabrication cost is increased. For a long time, the engineers cannot find a better method to prevent intrusion of the ESD along the cable, and only a casing protection is used to prevent intrusion of the ESD along the cable.

### SUMMARY OF THE INVENTION

The present invention is directed to an electrostatic discharge (ESD) protection structure and an electronic device using the same, in which pointed end structures used for discharging and signal lines are disposed on different film layers, and are connected through vias, so as to guide an ESD current to another side of a printed circuit board (PCB) for discharging. Since the pointed end structures and the signal lines are disposed on different film layers (or referred to as different conductive layers or metal layers) of the PCB, contact between a ground line connected to the pointed end structures and a flexible cable can be avoided, and meanwhile a layout area required by an ESD protection structure and a design difficulty can be reduced.

The present invention provides an ESD protection structure, which is adapted to a PCB substrate. The PCB substrate has a first conductive layer and a second conductive layer, and the PCB substrate has a plurality of signal lines for connecting a flexible cable, wherein the signal lines are formed by the first conductive layer of the PCB substrate, and the ESD protection structure includes a first discharge structure, a first via and a first conduction structure. The first discharge structure is formed by the second conductive layer of the PCB substrate, and the first discharge structure has a first pointed end. The first via is used for connecting the first discharge structure and a first signal line among the signal lines. The first conduction structure is formed by the second conductive layer of the PCB substrate, wherein the first conduction structure is connected to a ground line and has a second pointed end. Wherein, the first conductive layer and the second conductive layer are belonged to different film layers, and the first pointed end of the first discharge structure is adjacent to the second pointed end of the first conduction structure.

In an embodiment of the present invention, a plurality of vias is disposed between the first discharge structure and the first signal line to reduce impedance.

In an embodiment of the present invention, the ESD protection structure further includes a second discharge structure, a third via and a second conduction structure. The second discharge structure is foamed by the second conductive layer of the PCB substrate, and the second discharge structure has a third pointed end. The third via is used for connecting the second discharge structure and a second signal line among the signal lines. The second conduction structure is formed by the second conductive layer of the PCB substrate, wherein the second conduction structure is connected to the ground line and has a fourth pointed end. Wherein, the third pointed end of the second discharge structure is adjacent to the fourth pointed end of the second conduction structure.

In an embodiment of the present invention, the first conductive layer is located on a top side of the PCB substrate, and the second conductive layer is located on a bottom side of the PCB substrate. Moreover, the PCB substrate can be a multilayer PCB substrate.

In an embodiment of the present invention, the flexible cable is, for example, a flexible printed board (FPB), a heat seal or a flexible flat cable (FFC).

In an embodiment of the present invention, shapes of the first discharge structure and the first conduction structure are triangles, and the signal lines are gold fingers.

The present invention provides an electronic device including a PCB assembly, a flexible cable and an ESD protection structure. The PCB assembly includes a PCB substrate having a first conductive layer and a second conductive layer, wherein the first conductive layer and the second conductive layer are belonged to different film layers. The PCB substrate has a plurality of signal lines, and the signal lines are formed by the first conductive layer of the PCB substrate. The flexible cable is connected to the signal lines on the PCB substrate. The ESD protection structure includes a first discharge structure, a first via and a first conduction structure. The first discharge structure is formed by the second conductive layer of the PCB substrate, and the first discharge structure has a first pointed end. The first via is used for connecting the first discharge structure and a first signal line among the signal lines. The first conduction structure is formed by the second conductive layer of the PCB substrate, wherein the first conduction structure is connected to a ground line and has a second pointed end. Wherein, the first conductive layer and the second conductive layer are belonged to different film layers, and the first pointed end of the first discharge structure is adjacent to the second pointed end of the first conduction structure. The other implementations of the ESD protection structure in the electronic device are already described in the above content, and therefore detailed descriptions thereof are not repeated.

According to the above description, the present invention provides an ESD protection structure, in which the pointed end structures and the signal lines are disposed on different conductive layers, so as to avoid a contact between the ground line connected to the pointed end structures and the flexible cable to generate a signal error. Meanwhile, since the ESD protection structure and the signal liens are located at different conductive layers, a problem of crowded layout is avoided, so that a layout complexity is simplified.

In order to make the aforementioned and other features and advantages of the present invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating an electronic device according to an embodiment of the present invention.

FIG. 2A is a schematic diagram illustrating an ESD protection structure of A signal line 111 according to an embodiment of the present invention.

FIG. 2B is a schematic diagram illustrating an ESD protection structure according to another embodiment of the present invention.

FIG. 3 is a schematic diagram illustrating an ESD protection structure according to an embodiment of the present invention.

FIG. 4 is a schematic diagram illustrating discharge structures according to another embodiment of the present invention.

### DESCRIPTION OF THE EMBODIMENTS

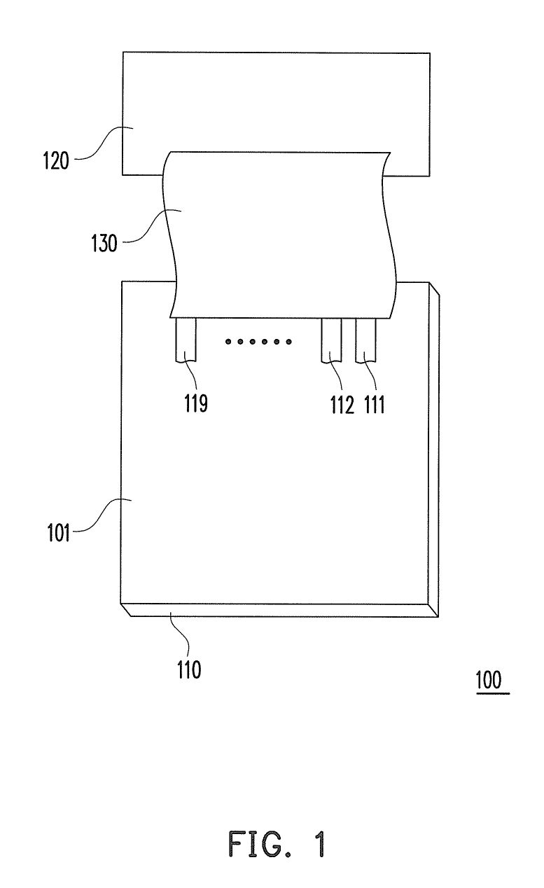

Referring to FIG. 1, FIG. 1 is a schematic diagram illustrating an electronic device according to an embodiment of the present invention. The electronic device 100 includes a printed circuit board assembly (PCBA) 101 and a flexible cable 130, wherein the flexible cable 130 is used for connecting the PCBA 101 and a rear-end device, for example, a liquid crystal display panel 120. The PCBA 101 includes a PCB substrate 110 and electronic devices (not illustrated) disposed thereon. The flexible cable 130 is, for example, a flexible printed board (FPB), a heat seal, or a flexible flat cable (FFC).

The PCB substrate 110 has a plurality of signal lines 111-119, and one end of the flexible cable 130 is connected to the signal lines 111-119. The signal lines 111-119 are formed by a first conductive layer (or referred to as a first metal layer) on a top side of the PCB substrate 110. Generally, the signal lines 111-119 connected to the flexible cable 130 are also referred to as gold fingers. The signal lines 111-119 are respectively connected to an electrostatic discharge (ESD) protection structure (not shown) located at a bottom side of the PCB substrate 110 through vias. The ESD protection structure is mainly formed by a conduction structure with a pointed end shape, in which an ESD current is guided to a ground line on the other side of the PCB substrate 110 for discharging according to a point discharge principle, so as to avoid the ESD current entering the PCBA 101 along the signal lines 111-119 to damage chip devices thereon.

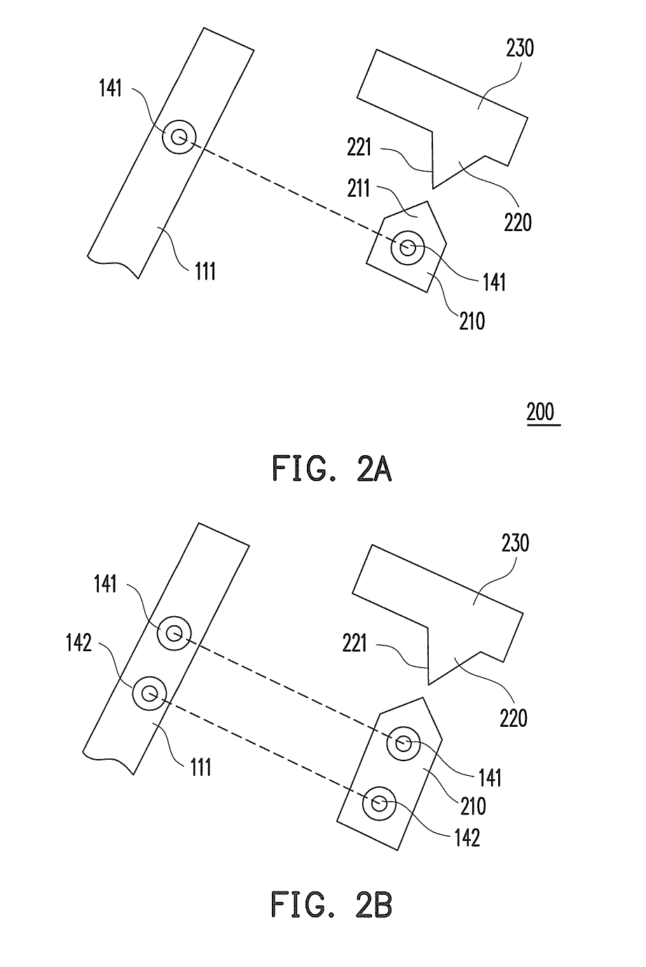

Referring to FIG. 2A, FIG. 2A is a schematic diagram illustrating an ESD protection structure of the signal line 111 according to an embodiment of the present invention. The ESD protection structure 200 mainly includes a via 141, a discharge structure 210 and a conduction structure 220. The signal line 111 is connected to the discharge structure 210 through the via 141, and the conduction structure 220 is connected to a ground line 230. The discharge structure 210 has a pointed end 211, and the conduction structure 220 has a pointed end 221, wherein the pointed end 211 is adjacent to the pointed end 221. It should be noticed that in the present embodiment, the discharge structure 210 and the conduction structure 220 are disposed on the bottom side of the PCB substrate 110, and are formed by a second conductive layer (or referred to as a second metal layer) on the bottom side of the PCB substrate 110.

Shapes of the discharge structure 210 and the conduction structure 220 are, for example, triangles, and as long as the structure has one pointed end, and the pointed ends are located adjacent to each other, it is considered to be applicable, so that designers can modify the shapes according to actual demands, which is not limited by the present invention. Referring to FIG. 2B, FIG. 2B is a schematic diagram illustrating an ESD protection structure according to another embodiment of the present invention. To increase a transmitting speed of current, a plurality of vias 141 and 142 can be configured between the discharge structure 210 and the signal line 111 to reduce an impedance of a current transmission path thereof, so as to increase a current transmission amount. Regarding a number of the configured vias, it is considered to be applicable as long as a layout requirement is met, which is not limited by the present invention.

Referring to FIG. 2A and FIG. 2B, according to the point discharge principle, the ESD current can be guided to the pointed end 211 of the discharge structure 210 for discharging, and is transmitted to the ground line 230 through the pointed end 221 of the conduction structure 220, so as to achieve the ESD protection effect. The ESD protection structures of the signal lines 112-119 on the PCB substrate 110 are the same to that described according to the embodiments of FIG. 2A and FIG. 2B. The discharge structure and the conduction structure corresponding to each of the signal lines 112-119 are configured on the bottom side of the PCB substrate 110 to protect the electronic device 100 from the ESD, and the discharge structures and the conduction structures are all disposed on the bottom side of the PCB substrate 110. It should be noticed that the discharge structures connected to the signal lines 111-119 are individually separated, though the corresponding conduction structures can be connected to the same ground line.

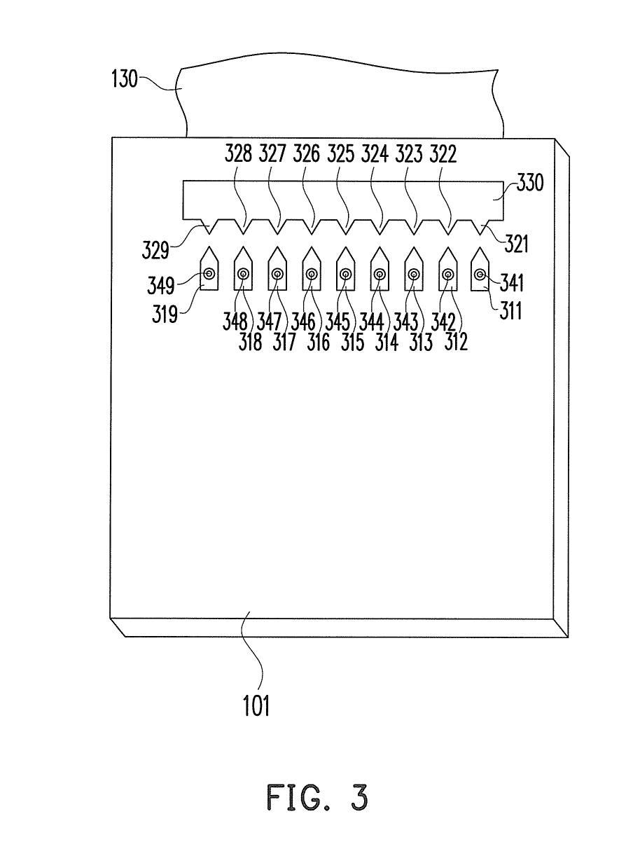

Referring to FIG. 3, FIG. 3 is a schematic diagram illustrating an ESD protection structure according to an embodiment of the present invention. In FIG. 3, the ESD protection structure located on the bottom side of the PCB substrate 110 is illustrated. The ESD protection structure includes a plurality of discharge structures 311-319 and a plurality of conduction structures 321-329, wherein the discharge structures 311-319 are respectively connected to the signal lines 111-119 on the top side of the PCB substrate 110 through vias 341-349. Pointed ends of the conduction structures 321-329 and pointed ends of the discharge structures 311-319 are disposed oppositely one another and are adjacent to one another, and the other ends of the conduction structures 321-329 are coupled to a ground line 330.

It should be noticed that though the ESD protection structure illustrated in FIG. 3 is disposed on the bottom side of the PCB substrate 110, the present invention is not limited thereto. If the PCB substrate 110 is a multilayer substrate, the ESD protection structure can be disposed at any conductive layer of the PCB substrate 110 as long as the signal lines 111-119 uses different conductive layers. In other words, in the present invention, the ESD protection structure and the signal lines are disposed at different film layers to avoid a contact between pins of the flexible cable 130 and the ESD protection structure that influences a signal transmission. Generally, the conductive layers of the PCB substrate 110 are copper foils, though the present invention is not limited thereto.

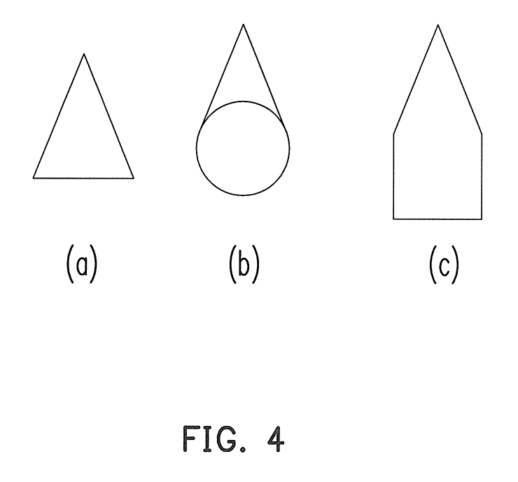

The discharge structure 210 of FIG. 2A is only an exemplary embodiment of the present invention, and the discharge structure of the present invention is not limited thereto. Referring to FIG. 4, FIG. 4 is a schematic diagram illustrating discharge structures according to another embodiment of the present invention. As shown in FIG. 4, the discharge structure is, for example, a triangle (FIG. 4(a)), a triangular cone-shaped (FIG. 4(b)), or a pentagon (FIG. 4(c)). Wherein, the shape illustrated in FIG. 4(b) is formed by integrating a shape of the via and a triangle. According to FIG. 4, it is known that the discharge structure of the present embodiment is mainly required to have a pointed end structure to facilitate point discharging, and a layout figure thereof is not limited.

In summary, the ESD protection structure and the signal lines are disposed on different conductive layers, so as to avoid a contact between the ESD protection structure and the flexible cable. Meanwhile, when a number of the pins is relatively more, a problem of crowded layout can also be resolved according to such layout method, so that the layout plan can be more flexible.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An electrostatic discharge (ESD) protection structure, adapted to a printed circuit board (PCB) substrate, the PCB substrate having a first conductive layer and a second conductive layer, and the PCB substrate having a plurality of signal lines for connecting a flexible cable, wherein the signal lines are formed by the first conductive layer of the PCB substrate, and the ESD protection structure comprising:
a first discharge structure, formed by the second conductive layer of the PCB substrate, and having a first pointed end;
a first via, connecting the first discharge structure and a first signal line among the signal lines; and
a first conduction structure, formed by the second conductive layer of the PCB substrate, wherein the first conduction structure is connected to a ground line and has a second pointed end,
wherein the first conductive layer and the second conductive layer are belonged to different film layers, and the first pointed end of the first discharge structure is adjacent to the second pointed end of the first conduction structure.

2. The ESD protection structure as claimed in claim 1, further comprising a second via for connecting the first discharge structure and the first signal line.

3. The ESD protection structure as claimed in claim 1, further comprising:
a second discharge structure, formed by the second conductive layer of the PCB substrate, and having a third pointed end;
a third via, connecting the second discharge structure and a second signal line among the signal lines; and
a second conduction structure, formed by the second conductive layer of the PCB substrate, wherein the second conduction structure is connected to the ground line and has a fourth pointed end,
wherein the third pointed end of the second discharge structure is adjacent to the fourth pointed end of the second conduction structure.

4. The ESD protection structure as claimed in claim 1, wherein the PCB substrate is a multilayer PCB substrate.

5. The ESD protection structure as claimed in claim 1, wherein the first conductive layer is located on a top side of the PCB substrate, and the second conductive layer is located on a bottom side of the PCB substrate.

6. The ESD protection structure as claimed in claim 1, wherein the flexible cable is a flexible printed board (FPB).

7. The ESD protection structure as claimed in claim 1, wherein the flexible cable is a heat seal.

8. The ESD protection structure as claimed in claim 1, wherein the flexible cable is a flexible flat cable (FFC).

9. The ESD protection structure as claimed in claim 1, wherein a material of the first conductive layer and the second conductive layer is copper foil.

10. The ESD protection structure as claimed in claim 1, wherein shapes of the first discharge structure and the first conduction structure are all triangles.

11. The ESD protection structure as claimed in claim 1, wherein the signal lines are gold fingers.

12. An electronic device, comprising:
a PCB assembly, comprising a PCB substrate having a first conductive layer and a second conductive layer, the first conductive layer and the second conductive layer being belonged to different film layers, and the PCB substrate having a plurality of signal lines, wherein the signal lines are formed by the first conductive layer of the PCB substrate;
a flexible cable, connected to the signal lines on the PCB substrate; and
an ESD protection structure, comprising:
a first discharge structure, formed by the second conductive layer of the PCB substrate, and having a first pointed end;
a first via, connecting the first discharge structure and a first signal line among the signal lines; and
a first conduction structure, formed by the second conductive layer of the PCB substrate, wherein the first conduction structure is connected to a ground line and has a second pointed end,
wherein the first conductive layer and the second conductive layer are belonged to different film layers, and the first pointed end of the first discharge structure is adjacent to the second pointed end of the first conduction structure.

13. The electronic device as claimed in claim 12, wherein the ESD protection structure further comprises a second via for connecting the first discharge structure and the first signal line.

14. The electronic device as claimed in claim 12, wherein the ESD protection structure further comprises:
a second discharge structure, formed by the second conductive layer of the PCB substrate, and having a third pointed end;
a third via, connecting the second discharge structure and a second signal line among the signal lines; and
a second conduction structure, formed by the second conductive layer of the PCB substrate, wherein the second conduction structure is connected to the ground line and has a fourth pointed end,
wherein the third pointed end of the second discharge structure is adjacent to the fourth pointed end of the second conduction structure.

15. The electronic device as claimed in claim 12, wherein the PCB substrate is a multilayer PCB substrate.

16. The electronic device as claimed in claim 12, wherein the first conductive layer is located on a top side of the PCB substrate, and the second conductive layer is located on a bottom side of the PCB substrate.

17. The electronic device as claimed in claim 12, wherein the flexible cable is a flexible printed board (FPB).

18. The electronic device as claimed in claim 12, wherein the flexible cable is a heat seal.

19. The electronic device as claimed in claim 12, wherein the flexible cable is a flexible flat cable (FFC).

20. The electronic device as claimed in claim 12, wherein a material of the first conductive layer and the second conductive layer is copper foil.

21. The electronic device as claimed in claim 12, wherein a shape of the first discharge structure is a triangle.

22. The electronic device as claimed in claim 12, wherein a shape of the first conduction structure is a triangle.
